(19) United States
(12) Patent Application Publication
(10) Pub. No.: US 2024/0243902 A1
(43) Pub. Date: Jul. 18, 2024

(54) METHOD FOR ENCRYPTED COMMUNICATION BETWEEN SYSTEMS USING PARALLEL KEY BANKS AND REDUCED CHARACTER SETS

(71) Applicant: Timothy James Regan, Saco, ME (US)

(72) Inventor: Timothy James Regan, Saco, ME (US)

(21) Appl. No.: 18/579,742

(22) PCT Filed: Jul. 16, 2022
(86) PCT No.: PCT/US2022/037403

§ 371 Date: Jan. 16, 2024

Related U.S. Application Data
(60) Provisional application No. 63/222,517, filed on Jul. 16, 2021.

(51) Int. Cl. H04L 9/08; H04L 9/32

(52) U.S. Cl. CPC H04L 9/0819; H04L 9/32

(57) ABSTRACT

The invention is a process with operations or steps by which separate systems can communicate information and data through encrypted transmissions of data which may include strings, numbers, or other characters. This ensures that the messages are secure from eavesdropping and imitation by third parties. Security is further enhanced by using a method of reduced character sets to transmit data between systems by means of meta bits that allow single encrypted data items to represent multiple possible meanings. The receiving system uses these details to check the integrity of the data and sending system before decrypting the message. A similar method is used by the receiving system to encrypt its output before returning it to the original system. This results in a bi-directional encrypted messaging system that is impervious to outside attempts at decryption.

### BACKGROUND TO THE INVENTION

### 1. Field of the Invention

The invention relates to the field of data encryption and communication between separate systems to enable the transmission and reception of information in an obfuscated form. This information may be in the form of a series of messages or simply used to identify remote parties in a communication system to ensure that the sender or recipient of the information is not an imposter.

### 2. Description of the Prior Art

Data encryption has been used in a variety of forms for centuries and has become widely used in communication, underpinning much of the functionality of communication in local systems and across the internet. Simple methods of encryption and decryption use substitution cyphers which modify or reorder the source data to make it unreadable by an external observer. A reverse method is used by a receiver to recreate the original message. More advanced systems use a set of parallel keys to encode and decode information while other methods use public and private keys based on “RSA” structures developed in the 1970s. The availability of increasingly powerful computers has meant that the calculations used to verify data integrity are completed in a fraction of a second.

Encryption cyphers are not usually found in modern encryption systems and parallel key methods have been replaced by public/private key encryption. Modern key encryption is often based on the concept of prime factorisation, where products of very large prime numbers are used to encode data for transmission. This method uses public and private keys which relate to very large prime numbers that only have single prime factors. Decrypting such numbers is nearly impossible by guesswork and incredibly time consuming using other methods. Public/private key based encryption became the standard in the computing industry and the technology is widely distributed and understood.

While public key encryption is reliable and secure, it is vulnerable if the keys or passwords used are stolen or compromised. If this should happen, communications between systems that rely on the key pair can be intercepted and decoded by an outside party. Once the system is compromised, the identify of remote recipients becomes difficult to verify and secret information may be decrypted and read by third parties.

### SUMMARY OF THE INVENTION

This invention provides a methodology that identifies the remote recipient of information as part of the information exchange using encryption keys that are reformed every time information is exchanged. This delivers a method of verifying the parties in the information exchange during data exchange or as a precursor to communication through other methods. The transmission and reception of a small amount of information can validate whether the remote party is the intended party for communication or data exchange.

The security of the system is maintained by the random selection of the key fragments and the methods used to process these key fragments to encode the data transferred between the systems. These have the effect of changing the encrypted contents of the data being transmitted and received, every time the parties in the system communicate. This is true even when identical messages are transmitted repeatedly, making it impossible to discern patterns to reverse engineer or change the data through an eavesdropping system.

An advantage of this invention over other encryption methods is that the values of the long encryption keys used by the sending and receiving systems are constantly changing. Even if an eavesdropper had access to the key banks, the combination pattern for the key fragments is modified every time they are used by methods locked within the systems. This delivers a high level of security as the encryption methods can be made using ‘one-way’ mathematical functions that cannot be reversed to reveal the input data. Functions with multiple possible sources, such as the modulus function, can be used in any combination and any number of times to encrypt the data making it impossible for an external source to replicate the information in the data packets.

The invention provides a tamper-proof method of communication between two systems to validate the identity of the sending and receiving parties and to securely send encrypted information. The method uses parallel banks of encryption keys as a base and manipulates these keys before combining them on to a longer key to encrypt information. These keys are stored in a fragmented form and selected at random before being modified and combined in different ways every time two systems communicate, giving a unique cipher every time information is transmitted or exchanged. The combined fragments generate a key that can be used to encrypt the message. This is called the Long Encryption Key.

Key Bank

| | | | | | |
|---|---|---|---|---|---|
| 1a = AaA | 1b = AbA | 1c = AcA | 1d = AdA | 1e = AeA | 1f = AfA |
| 2a = BaA | 2b = BbB | 2c = BcB | 2d = BdB | 2e = BeB | 2f = BfB |
| 3a = CaA | 3b = CbC | 3c = CcC | 3d = CdC | 3e = CeC | 3f = CfC |
| 4a = DaA | 4b = DbD | 4c = DcD | 4d = DdD | 4e = DeD | 4f = DfD |
| 5a = EaA | 5b = EbE | 5c = EcE | 5d = EdE | 5e = EeE | 5f = EfE |

### Keys Selected at Random

Key3c Key5b Key1f Key3e Key3a Key2d

### Simple Long Encryption Key

CcC EbE AfA CeC CaC BdB

The keys from the key bank are combined to form the Long Encryption Key to encode the words and message in the transmission. Keys in a working system would be of varying length and contain randomized text strings.

Encryption and decryption are achieved by encoding information with a key which is built from smaller key fragments selected from large banks of keys inside each system that participates in the information exchange. The keys are short sets of characters that are joined to create a long encryption cipher. This long encryption cipher serves three purposes: to confirm the identity of the parties in the information exchange, to protect the integrity of the transmission and to encrypt and decrypt a message.

Encryption keys are selected and re-encoded by the transmitting system (System A) before being used to encrypt the data to be transmitted. The identity of the keys and subsequent encoding instructions are contained within the encrypted data and transmitted to the receiving system (System B). System B retrieves matching keys from a parallel key set which will match the ones used to encrypt the message and these are used to decrypt and verify the information received.

Keys may be re-encoded prior to their inclusion in the long key. This may involve changing the position of characters in the short keys or adjusting them by a given value. In this example, each third character is increased by three.

### Simple Long Encryption Key

CcC EbE AfA CeC CaC BdB

### Modified Long Encryption Key

CcF EbH AfD CeF CaF BdE

The combination of the keys can also change in the process of building the Long Encryption Key. The order of the key fragments may be altered, or they may be combined rather than concatenated. Keys and encoding methods are likely to be larger and more complex in application.

### Keys Selected at Random

Key3c Key5b Key1f Key3e Key3a Key2d

### Simple Long Encryption Key

CcC EbE AfA CeC CaA BdB

### Modified Order Encryption Key

Key3a Key2d Key5b Key3e Key3c Key1f

### Re-Combined Long Encryption Key

CcA BdB EbE CeC CcC AfA

The re-encoding and combination may be performed multiple times before being used for encryption of the message before transmission. Methods of combination can be concatenate the keys or interleave them in a variety of ways to for new sequences.

The message is encrypted by adjusting each character by a corresponding character in the Long Encryption Key. This may be a case of simple addition or a more complex formula. In this example, each letter is increased by its corresponding value in the encryption key if the encryption letter is in upper case and decreased by that value if it is in lower case. If the result is lower than ‘a’ or higher than ‘z’, the value loops back to the beginning or end of the alphabet and continues.

### Original Message

Somedatatosend

### Simple Long Encryption Key

CcCEbEAfACeCCaCBdB

### Encrypted Message

Vlpjbfuuurnhqc

| | | | | | | | | | | | | | | |
|---|---|---|---|---|---|---|---|---|---|---|---|---|---|---|
| Source Letter | S | o | m | e | d | a | t | a | t | o | s | e | n | d |
| Key Letter | C | c | C | E | b | E | A | f | A | C | e | C | C | a |
| Key Action | +3 | −3 | +3 | +5 | −2 | +5 | +1 | −6 | +1 | +3 | −5 | +3 | +3 | −1 |
| Encrypted | V | l | p | j | b | f | u | u | u | r | n | h | q | c |
| Value | | | | | | | | | | | | | | |

Other characters outside the Latin alphabet such as spaces and punctuation can be encrypted in the same way. This can be extended to include the full ASCII standard data set. Other languages can be represented in the same fashion.

The encrypted message may consist of a long string of characters from the ASCII instruction set or some other form of structured data.

The information in Packet A sent from System A to System B contains seven elements:
List of keys.
Method used for subsequent key manipulation and encoding.
Word 1
Word 2 (encryption of Word 1)
Encrypted message.
Meta bits
Random characters

To start the exchange, System A selects a random set of key fragments from its internal key bank. These keys are manipulated and altered by methods defined within the system and joined together to form one long key for data encryption. This long key may be formed by connecting the key fragments together in a contiguous sequence or by more complex methods such as joining the first character of the key fragments together, followed by the second, etc. Myriad joining methods may be defined within the systems and any one selected and used at any time. As with the key selection and manipulation, the joining methods are chosen at random or by one or multiple pre-defined sequences.

When the Long Encryption Key has been generated, System A generates a random string of characters to use as a source ‘Word’, defined in the invention as Word 1a. This may be a set length or the length of Word 1a can be indicated in the data sent to System B. The source word is encoded using the long key to generate an encrypted version of itself, defined as Word 2a.

If the exchange between the systems is simply used to identify the sender of the message and the identity of the recipient, the keys, source and encrypted words are sufficient. The system may also include specific messages which are encrypted by a similar method using the long encryption key.

In order to further obscure the message, the information can be transmitted using a reduced character set. This would compress the data to be represented by a series of characters that do not necessarily represent the content of the message. For example, a message could be transmitted using only lower-case characters even though its true content contained both upper and lower-case characters along with numbers and special characters. This is achieved using meta bits in the information string that tell the receiving system whether a character is to be read in its native form or if it should be switched to alternative values. The meta bits can be held anywhere in the information string and their position can be indicated by a character in the data packet or by other means.

A single meta bit can control multiple information characters by collecting a series of binary values in to a single ascii character. In a single character case example containing 26 possible letters, four information characters can be contained in a single ascii letter using binary coding. Larger character sets such as upper and lower-case information can carry more meta bits in a single character value.
Original message: This Is Some Text
Modified message: this is some text
Meta Bits: 10000100100001000 (1 represents upper case, 0 represents lower case)
Grouped Meta Bits: 1000 0100 1000 0100 0
Encoded Meta Bits: 1000=h (a+8) (The bits are combined to form the binary value of
   0100=d (a+4) an ASCII letter for inclusion in the message)
   1000=h (a+8)
   0100=d (a+4)
   0=a (a+0)
Final Meta Bits: hdhda
Final message: this is some texthdhda

### System A

| | | | | | | | | | | | | | | | | | |
|---|---|---|---|---|---|---|---|---|---|---|---|---|---|---|---|---|---|
| Input | T | h | i | s | | I | s | | S | o | m | e | | T | e | x | t |
| Meta Bit | 1 | 0 | 0 | 0 | 0 | 1 | 0 | 0 | 1 | 0 | 0 | 0 | 0 | 1 | 0 | 0 | 0 |
| Output | t | h | i | s | | i | s | | s | o | m | e | | t | e | x | t |

This allows text to be transferred using 27 characters (a-z and the space character). Extending the character set to 52 characters (a-z and A-Z) allows the full ASCII character set to be transmitted using the same methodology. Characters outside the core 52 letters would be represented by a meta bit for each letter in the message. The final message would be encoded by the long key as part of the encryption process and so the text and meta bits would be obscured.

System B take the meta bit information in the message and uses it to replicate the original message text. It converts the meta bit ASCII letters back to individual bits and processes the message accordingly.
Decoded Meta Bits: h=1000 (a+8) (The bits are combined to form the binary value of
   d=0100 (a+4) an ASCII letter for inclusion in the message)
   h=1000 (a+8)
   d=0100 (a+4)
   a=0 (a+0)

### System B

| | | | | | | | | | | | | | | | | | |
|---|---|---|---|---|---|---|---|---|---|---|---|---|---|---|---|---|---|
| Input | t | h | i | s | | s | s | | s | o | m | e | | t | e | x | t |
| Meta Bit | 1 | 0 | 0 | 0 | 0 | 1 | 0 | 0 | 1 | 0 | 0 | 0 | 0 | 1 | 0 | 0 | 0 |
| Output | T | h | i | s | | I | s | | S | o | m | e | | T | e | x | t |

System A gathers the elements of the message including Word 1a, Word 2a, key fragment identity information, meta bits, and encrypted message. This data may be further obscured by adding random characters to the message and scattering it among the useful message information. The location of the key, encrypted message and meta bit data in the text string can be altered using a variety of methods further obfuscate the data. Once this is complete, System A combines all this information in a message and sends it in a single data packet to System B. This is called Packet A.

When System B receives Packet A, it identifies the elements that comprise the word, key, message, and meta bit information amongst any random text. This may be done using pre-determined methods such as placement in specific locations or through identifying elements in the message text that tell it where to look. System B then extracts information about the key fragments and selects identical key fragments from its own internal key bank. The method used to manipulate these key fragments is also extracted from Packet A and the keys modified according to this information. These fragments are then joined and manipulated using the method described in Packet A to generate a Long Encryption Key on System B that will match that used by System A.

Word 1a and Word 2a are extracted from Packet A and System B encrypts Word 1a using the encryption key it built from its own key bank. This produces an internal word, defined as Word 2b. Word 1b received in Packet A is compared the value of Word 2b generated internally by System B. If they match, the integrity of the sender is confirmed. If Packet A also contains a message, System B can use the long key to decode it before proceeding. The message and meta bits are extracted from the information in packet A and decoded using the long key generated by System B.

System B may act based on the data received and could return a message to System A or transmit information to further systems using a similar method. System B selects a new set of keys at random from its internal key bank which are then manipulated and combined to form a long key. A new source word and encrypted word are generated using this key using similar methods to those used during transmission by System A. These are used to generate a key which then encrypts a return message. The message sent by System B may also use meta bits to compress the character set within the message. The word information is combined with the encrypted message and meta keys for return to System A or forwarded to subsequent systems. The receiving system can decrypt Packet B in a similar way to confirm the integrity of System B and extract any message it contains.

To further enhance security, the sending and receiving systems perform a parallel internal encryption step that is never transmitted and so is invisible to eavesdropping third parties. System A and System B take Word 2 and re-encrypt it internally using one of a series of pre-defined methods that are only available to the systems on the network. This method may also be informed by the data in the Packets to instruct the systems which encryption method to use or to give seeding information to encryption functions. This re-encrypted word is defined as Word 3, and it is used as a basis for any next steps in data processing. As this word is never part of the data exchange, it is impossible for it to be discovered by an intercepting system or generate it by other means. Word 3 gives a synchronous point by which the two systems can encrypt further communications without Word 3 being explicitly passed between them. This re-encoding process may involve any combination or re-assignment of the key fragments used to create Word 2 which can also be processed using mathematical formulae.

System B picks a new set of keys at random from its internal key bank, combines and manipulates then and then uses them to re-encrypt Word 3 to create Word 4. This ensures the value for Word 4 will change every time the System A and System B communicate, even if the originating message remains the same each time.

Word 4 is then combined with encryption information to generate a new word, Word 5. Key fragments from the internal key bank are selected at random and then modified and combined into a Long Encryption Key using a plurality of methods that are similar to those described above. This key is used to encrypt Word 4 to generate Word 5.

When this is complete, the returning data packet, Packet B, can be prepared for transmission. Word 4 and Word 5 are combined in Packet B, along with information describing the keys used for encryption. If an answering message is to be sent, it can be modified using meta bits and encoded with the encryption keys used to generate Word 5 and added to the Packet B. The data in this packet may also be further obfuscated by adding random data among this useful message information.

The information in the Packet B sent from System B to System A contains seven elements:
List of keys.
Method used for key manipulation and encoding.
Word 4 (encryption of internal word 3)
Word 5 (encryption of Word 4)
Encrypted message.
Meta bits
Random data

When System A receives Packet B, it decrypts the information using similar methods to those used by System B. The identity of the key fragments is extracted from the data from Packet B then adapted and combined according to combination and formulaic methods used by System B. This generates a value of Word 4 on System A based on its internal value of Word 3. This is then compared to the value of Word 4 returned from System B. If the returned Word 4 matches the Word 4 generated on System A, System A proceeds to build the full encryption key from its internal key fragment bank and uses it to generate Word 5. If the Word 5 value generated by System A matches the Word 5 value returned by System B, the identity of System B is confirmed. If System B included a message in the return data, this can be decrypted using the same encryption key used to generate Word 5.

### BRIEF DESCRIPTION OF DRAWINGS

FIG. 1a shows the simplest form of communication between systems. An encrypted message from System A is sent to System B in Packet A. The data in Packet A changes on every instantiation, even if the instruction is the same each time. System B decodes the message to verify System A's identity and acts on the instructions received in Packet A.

FIG. 1b shows bidirectional communication between two systems. Packet A is sent from System A to System B containing an encrypted message. System B decodes Packet A, formulates a response and returns a message in Packet B. The data in Packet B will be encrypted by creating a Long Encryption Key built from System B's internal key banks and the message encrypted accordingly.

FIG. 2 shows the start of a process incorporating the invention where System A selects a group of cipher keys from an internal bank of key fragments and combines them in a multitude of ways to form an encoding cipher called the Long Encryption Key. This is used to encode a randomly generated data set to form the encrypted Word 2a from the source Word 1a. This data is also used to encrypt information for transmission to another system in the network defined as System B. The keys and message information are sent via a data set called Packet A. System A then goes on to create Word 3a which will be held internally. This will match a process on System B which will create Word 3b which will match. System A will also use Word 3a to create Word 4a in preparation for receiving Packet B.

FIG. 3 shows the steps taken by System B to unpack, verify and decode the information in Packet A. System B locates the elements of Packet A that contains information on the key fragments to be used and how these must be combined and manipulated to form a Long Encryption Key. Word 1a is extracted and replicated internally as Word 2a. The encryption information is then used to generate Word 2b on System B and this is compared to the value of Word 1b. If the values match, the integrity of the sender is confirmed. The message and meta bit information is also extracted from Packet A and the Long Encryption Key generated by System B is used to decrypt the message. System B may then act on this information or create its own message to return to System A. Similar methods can also be used to transmit information to other systems in turn. To return or forward a message, System B performs a further series of encryption steps to generate an internal value for Word 3b based on Word 2b. This value is never transmitted and is only used to create Word 4b. This will match a parallel internal process on System A which will generate Word 3a which will match Word 3b. System B then generates a value for Word 5b which will be included in Packet B and used by System A to verify the integrity of the sender. System B generates a message and packages it with Word 4b, Word 5b, meta bits and key information and any random data and returns it to System A.

FIG. 4 shows System A receiving Packet B. System A locates the elements of Packet B that contains information on the key fragments to be used and how these must be combined and manipulated to form a Long Encryption Key. System A will use this key to encrypt its internal Word 3a to create Word 4a. This is compared to Word 4b in the encrypted information received from System B and then used to create 5a. If the values of Word 4a and Word 4b along with Word 5a and Word 5b match, the integrity of the sender is confirmed. The Long Encryption Key is then used to decode the message and generate an output.

### DETAILED DESCRIPTION OF THE INVENTION

The present invention is a methodology for one system to send a message to another system in an encrypted form or for a system to send a request for a decision to a separate system and receive an answer in separate encrypted messages. The data is sent in packets of information containing alpha-numeric strings or other data types that are encrypted to prevent them being read, compromised, tampered with, or forged by an external party.

The data is encrypted using a Long Encryption Key that is recreated from key fragments every time a message is sent. The constant regeneration of the encryption key means that the packets of information transmitted and received change on every occasion, even if identical data are fed at the input. By encoding the information this way, the messages cannot be decoded, replicated, or modified by any external method as the method to encrypt them is constantly changing. Furthermore, checking methods withing the system ensure that messages cannot be forged as these will be recognised by the system and the message discarded as invalid. The data set is further protected by reducing the set of characters exchanged between systems using meta bits which allow the compressed character set to contain a far wider range of information than that which is presented in the message.

Security is enhanced further by the sending and receiving party performing internal parallel processing steps as part of the encryption process. This results in identical encryption keys that are held internally by the sending and receiving parties but are never explicitly transmitted or exchanged. This key will be renewed every time systems exchange information through multiple possible steps, so it is not possible for eavesdropping parties to predict or replicate the key through other means.

The method used to encrypt and decode the data redefines both the key and the lock on each side of the system on every occasion that it is used. The data transmitted includes an encrypted description of the cypher key fragments and instructions on how to modify and combine them to generate a Long Encryption Key to decode the information. The answering system generates keys in the same fashion, sending its response back to the originating system which creates parallel key information to decode the answering message. The data sent in each direction are encoded by separate cipher keys which change during every cycle.

The invention relates to separate systems that must communicate with each other. For simplicity, two systems are represented but multiple sending and receiving systems could work using the same principle. The sending system is described as “System A” and receiving system is “System B”. The data transmitted and received may be in any form but is represented as character strings for clarity.

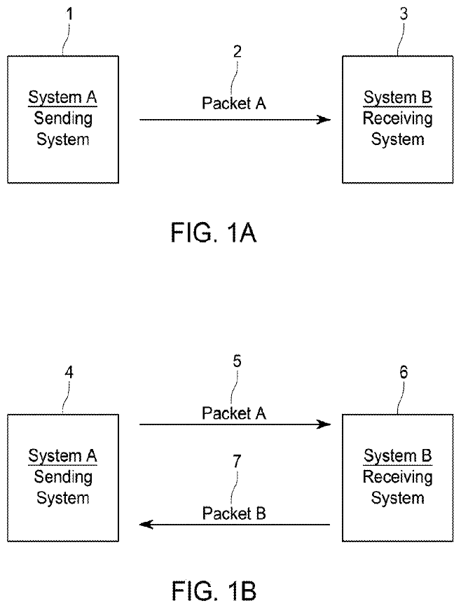

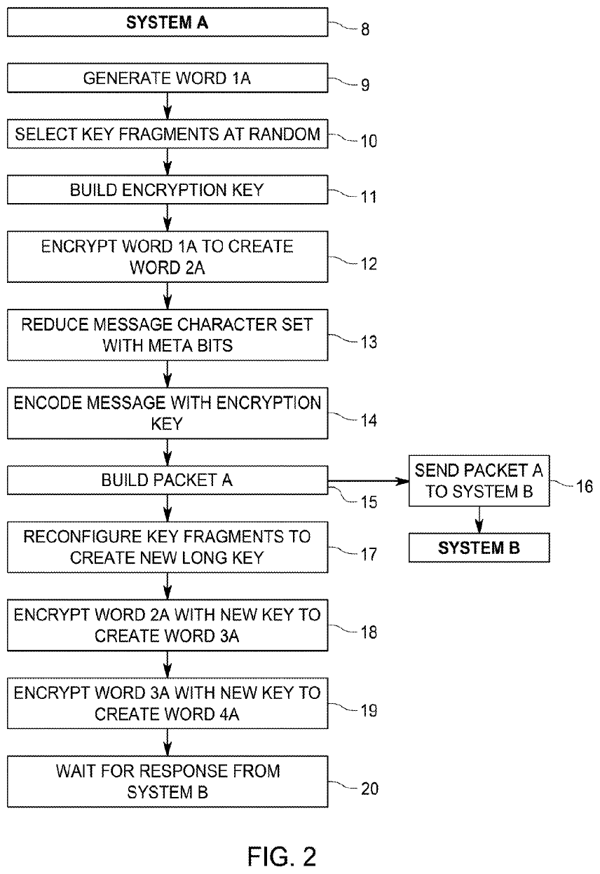

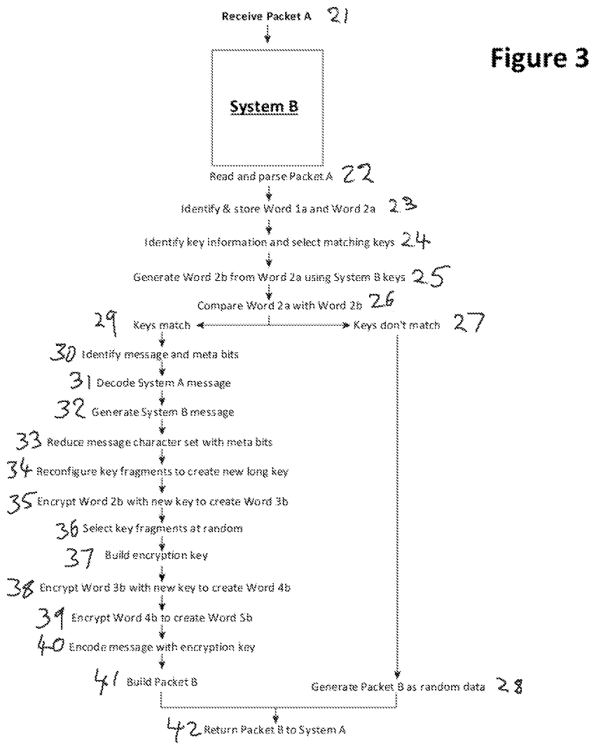

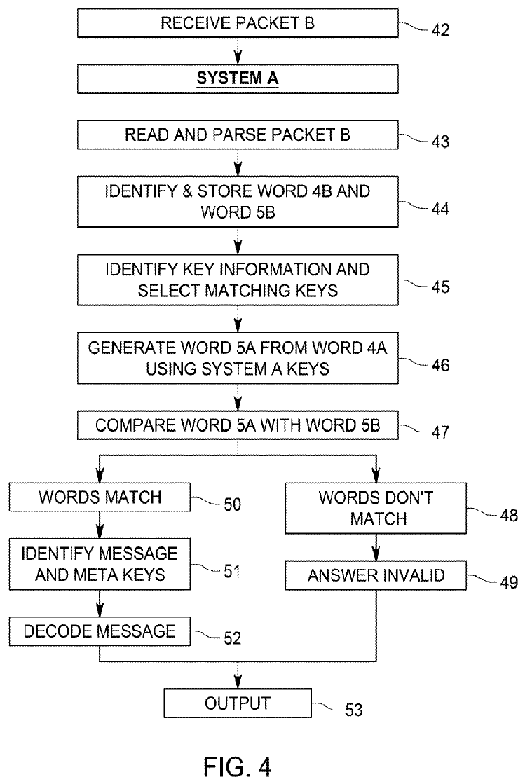

With reference to FIGS. 1-4, the system may work in a unidirectional manner where System A sends an encrypted message (1) in a data packet (2) to System B (3). The same method is used for bidirectional communication where System A (4) sends an encrypted message in Packet A (5) to System B (6) which decodes and interprets the message before sending an encrypted message in return in Packet B (7) to System A.

System A and System B have a common set of small cypher key fragments in a form that is hidden from the user and outside scrutiny. The keys are held in internal banks that are only accessible to the systems and are selected at random from an index. Each key is much shorter than the data being encrypted so multiple keys are joined together to make a key that matches or exceeds the length of the data to be processed. The keys may be manipulated after selection and the method to join the keys fragments together varies every time the system is executed with a method that may depend on pre-determined steps or through random selection. Selecting the cipher keys at random and joining them together in the fashion has the effect of generating a new cipher key every time the system is run.

System A (8) generates a random initial character set described as Word 1a (9). Key fragments are drawn from its internal key bank (10) and these are modified through a variety of mathematical functions then connected to build a long key for encryption (11). System A encrypts Word 1a based on the cipher which generates a second character set, Word 2a (12). Word 1a and Word 1b will enable System B to perform and integrity check on the data it receives. The message within Packet A may be compressed to a reduced character set using meta bits (13) which will further obfuscate the data. Once this is complete, the message is encoded with the long encryption key (14). Word 1a, Word2a, key references meta bits and the message are collected in Packet A (15) which is sent to System B (16). This message may also include random characters to further obfuscate its contents.

While waiting for an answer from System B, System A reconfigures the key fragments that were selected to build Packet A (17). This may be done through a variety of mathematical functions as standalone processes or through further application of the cipher data. The reconfigured long key is used to encrypt Word 2a to create a new word defined as Word 3a (18). Word 3a is held internally and not sent as part of a message exchange. Word 3a is encrypted again to generate Word 4a (19) which will be compared with the data returned from System B. When these steps are complete, System A waits until data is returned from System B in Packet B (20).

Upon receiving data Packet A (21), System B examines the information and parses it in to sections as specified in the obfuscated information contained in Packet A (22). This will allow the System B to separate the words, keys, message and meta bits for processing. The index information for the ciphers to be used can be extracted and matching key fragments can be selected from System B's key bank (24). These keys are modified and combined to form a long key and System B uses the long key it generated to encrypt Word 2a which will create Word 2b (25). Word 2b is compared to Word 1b (26) to verify that the data received is valid. If the comparison fails (27), System B will generate a message containing random data to return to system A (28). If Word 2b matches Word 1b (29) the receiving system will identify the message and meta bits (30) and the message will be decrypted using the long key created withing system B (31).

System B can generate its own message (32) and reduces the character set in the message using meta bits (33). The key fragments used to decrypt Word 2a to create Word 2b are modified and recombined to match the parallel process in System A (34). Word 2b is encrypted with the resulting long key to generate Word 3b (35). This gives System B a value for Word 3b that matches that held internally by System A in the form of Word 3a.

System B selects key fragments at random from its own key bank (36) and these are modified and connected to build a long key for encryption (37). Word 3b is encrypted with this new long key to create Word 4b (38). Word 4b is encrypted with this long key to create Word 5b (39). The message for return to System A may be compressed using meta bits and then encrypted with the key used to create Word 4b (40). This encryption key may also be modified using similar methods to those used to generate previous Words to further obfuscate the data. The encrypted message is joined with Word 4b and Word 5b and meta keys along with random data in a plurality of different ways to hide their contents. This creates Packet B in preparation for return to System A (41).

System A receives Packet B (42) and parses the information to extract Word 4b, Word 5b, key information the message and meta bits (43). Word 4b and Word 5b are stored (44) and a long key is built based on the information transmitted by System B (45). This key is used to generate Word 4a from System A's internal value of Word 3a. A further encryption step generates Word 5a from Word 4a (46) and Word 5a is compared to Word 5b (47). If the words don't match (48), the message from System B is deemed to be invalid (49). If the two words do match (50), System A identifies the message and meta bits in Packet B (51) and the message is decoded (52). This will then be output from System A for further use (53).

The method of the invention described is carried out as an improvement to a computing device is configured with a set of functions established with one or more computer programs that enable the performance of functional steps associated with the method described herein. The computing device may be configured as local or remote computing means, such as one or more central computers, such as one or more servers in a local area network, a metropolitan area network, a wide area network, or through intranet and internet connections.

The computing device may include one or more discrete computer processor devices. Examples of known computer processing devices that may be suitable for use in carrying out the functions of the invention include, but are not limited to, personal computers, server computers, hand-held or laptop devices, cellular phones including smartphones, multiprocessor systems, microprocessor-based systems, set-top boxes, programmable consumer electronics, network PCs, minicomputers, mainframe computers, distributed computing environments that include any of the above systems or devices, and the like. The computing device may be operated by one or more users, such as through a desktop, laptop, or servers, and/or one or more providers of services corresponding to one or more functions of the invention.

One or more relational databases may form part of or be associated with the computing device for the purpose of entering and accessing data of the type described herein. The relational database of the present invention is used for gathering, storing, and making accessible information associated with carrying out the steps described wherein the information is acquired from one or more sources. For the purpose of the description of the present invention, a database is a collection of stored data that are logically related. Although there are different types of databases, and the database of the present invention may be any of such types, it is preferably a relational database with a relational database management system, comprising tables made up of rows and columns. Data stored in the relational tables are accessed or updated using database queries submitted to the database system. The database may be populated and updated with information provided by an application provider capable of carrying out one or more of the steps associated with the method of the invention.

The steps of the method of the present invention may be described in the general context of computer-executable instructions, such as program modules, being executed by the computing device as one or more algorithms. Generally, program modules include routines, programs, objects, components, data structures, etc. that perform particular tasks or implement particular abstract data types. As indicated above, the method of the present invention may also be practiced in distributed computing environments where tasks are performed by remote processing devices that are linked through a communications network or other data transmission medium. In a distributed computing environment, program function modules and other data may be located in both local and remote computer storage media including memory storage devices. Storage of program instructions and database content may thereby be cloud-based as they can be stored on remote servers and accessed through internet-based connections.

The computer processor and interactive drives, memory storage devices, databases and peripherals may be interconnected through one or more computer system buses. The system buses may be any of several types of bus structures including a memory bus or memory controller, a peripheral bus, and a local bus using any of a variety of bus architectures. The computing device may include a variety of computer-readable media. Computer-readable media can be any available media that can be accessed by one or more processors of the computing device and includes both volatile and non-volatile media, removable and non-removable media. By way of example, and not limitation, computer-readable media may comprise computer storage media and communication media. Computer storage media includes volatile and non-volatile, removable, and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by the computer system. The computing device may also include computer storage media in the form of volatile and/or non-volatile memory such as Read-Only Memory (ROM) and Random-Access Memory (RAM). RAM typically contains data and/or program modules that are accessible to and/or operated on by one or more processors of the computing device. That is, RAM may include application programs, such as the particle image analysis functions of the present invention, and information in the form of data.

A user may enter commands and information into the computing device through input devices such as a keyboard, a touchpad, or a pointing device such as a mouse. Other input devices may include a microphone, joystick, game pad, satellite dish, scanner, or the like. These and other input devices are connected to the computer processor through the system bus, or other bus structures, such as a parallel port, game port or a universal serial bus (USB) but is not limited thereto. A monitor or other type of display device is also connected to the computing device through the system bus or other bus arrangement.

The computing device may be configured and arranged to perform the described functions and steps embodied in computer instructions stored and accessed in any one or more of the manners described. The functions and steps, such as the functions and steps of the present invention described herein, individually or in combination, may be implemented as a computer program product tangibly as non-transitory computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by one or more processors of the computing device, instruct the computer processor(s) to perform one or more processes or acts described herein, and/or various examples, variations and combinations thereof. Such instructions may be written in any of a plurality of programming languages, including for example, but not limited to XML, Java, Visual Basic, C, or C++, and the like, or any of a variety of combinations thereof. The computer-readable medium on which such instructions are stored may reside on one or more of the components described above and may be distributed across one or more such components.

1. A method for identifying a remote recipient of information as part of an information exchange between two systems, the method comprising the steps of:
reforming encryption and decryption keys every time information is exchanged between the two systems so as to verify parties in the information exchange during encrypted data exchange or as a precursor to communication, and
wherein transmission and reception of a small amount of information can validate whether a remote one of the parties is an intended party for communication or data exchange.

2. The method of claim 1 further comprising the step of enabling one of the parties to confirm the integrity of the other of the parties as part of the encrypted data exchange.

3. The method of claim 1 comprising the use banks of keys for data encryption.

4. The method of claim 1 wherein the step of reforming the encryption and decryption keys is accomplished by manipulating and combining key fragments into longer keys.

5. The method of claim 2 further comprising the step of encoding encryption and decryption instructions as part of data communicated between the parties.

6. The method of claim 1 further comprising the step of carrying out parallel internal encryption to obfuscate methods used to process the information.

7. The method of claim 1 for securing an exchange of data further comprising the step of compressing the data into a smaller character set using meta bits to control characters within a data packet.

8. The method of claim 1 further comprising the step of hiding message data amongst other random information as part of a communicated message.

9. The method of claim 1 further comprising the step of encrypting information before transfer from a sender party to a receiver party of the parties.

10. The method of claim 1 wherein a receiving party of the parties validates an identity of a sender party of the parties and verifies the data transmitted from the sender party.

11. The method of claim 10 wherein the receiving party decrypts data received from the sender party.

12. The method of claim 11 wherein the receiving party generates an encrypted response based on the data received from the sender party.

13. The method of claim 1 further comprising the step of encapsulating decision steps to further randomise the encryption of data.

14. The method of claim 1 further comprising the step of communicating binary decisions in encrypted form without the need to decode the encrypted data.

15. The method of claim 1 further comprising the step of linking the steps of claim 1 between a sender party of the parties to other systems to facilitate encrypted communication therebetween.
